(19) United States
(12) Patent Application Publication
(10) Pub. No.: US 2012/0133085 A1
(43) Pub. Date: May 31, 2012

(54) CERAMIC GREEN SHEET DRYING APPARATUS AND METHOD OF FABRICATING CERAMIC GREEN SHEET USING THE SAME

(75) Inventors: Won Seop CHOI, Suwon (KR); Dae Bok OH, Seoul (KR)

(73) Assignee: SAMSUNG ELECTRO-MECHANICS CO., LTD.

(21) Appl. No.: 13/091,758

(22) Filed: Apr. 21, 2011

(30) Foreign Application Priority Data
Nov. 26, 2010 (KR) 10-2010-0118909

(51) Int. Cl. B28B 1/30; B28B 11/00

(52) U.S. Cl. 264/500; 425/405.1

(57) ABSTRACT

There is provided a method of fabricating a ceramic green sheet, the method including: forming a ceramic green sheet by applying ceramic slurry onto a support substrate; and drying the ceramic green sheet by allowing the ceramic green sheet to pass through a plurality of drying zones, wherein positive internal differential pressure is applied to at least one of drying zones disposed at a front end of the plurality of drying zones, the internal differential pressure being defined as a pressure value obtained by subtracting a discharging pressure (Pₒᵤₜ) of each drying zone from an introducing pressure (Pᵢₙ) thereof.

### CROSS-REFERENCE TO RELATED APPLICATIONS

This application claims the priority of Korean Patent Application No. 10-2010-0118909 filed on Nov. 26, 2010, in the Korean Intellectual Property Office, the disclosure of which is incorporated herein by reference.

### BACKGROUND OF THE INVENTION

1. Field of the Invention

The present invention relates to the fabrication of a ceramic green sheet, and more particularly, to a ceramic green sheet drying apparatus for removing a solvent from a ceramic green sheet and a method of fabricating a ceramic green sheet using the same.

2. Description of the Related Art

With the rapid development of the information industry, the demand for compact and lightweight electronic devices has increased. Accordingly, the demand for a reduction in the volume or thickness of various electronic components and an improvement in functions per unit size has significantly increased.

The above-mentioned demand is also applied to a ceramic electronic component such as a multilayer ceramic capacitor. Therefore, various schemes have been considered. For example, in the case of a multilayer ceramic capacitor, in order to increase the capacitance thereof and reduce the size thereof, attempts to thin dielectric layers, forming the multilayer ceramic capacitor, may be considered.

However, when dielectric layers are thinned, problems such as the generation of short-circuits and a reduction in breakdown voltage, or the like may result in the deterioration of electrical reliability. In order to solve the problems resulting from thinned dielectric layers, it is necessary to fabricate a defect-free dielectric layer. Particularly, when the dielectric layer is very thin, the electrical characteristics of the multilayer ceramic capacitor may be significantly deteriorated even with a very small defect.

In order to prevent defects, it is necessary to maintain a ceramic green sheet in a defect-free state before firing. Accordingly, it is very important to develop a technology for fabricating a defect-free ultra-thin ceramic green sheet in fabricating a multilayer ceramic capacitor having ultra capacitance.

That is, unless the density of the ceramic green sheet for the dielectric layer is maximized and an increase in defects, deterioration in strength, and the like, caused due to thinning are minimized, the electrical characteristics of the multilayer ceramic capacitor may not be realized.

### SUMMARY OF THE INVENTION

An aspect of the present invention provides a method of fabricating a ceramic green sheet that does not have defects by improving a drying scheme.

Another aspect of the present invention provides a ceramic green sheet drying apparatus for fabricating a defect-free ceramic green sheet.

According to an aspect of the present invention, there is provided a method for fabricating a ceramic green sheet, including: forming a ceramic green sheet by applying ceramic slurry to a support substrate; and drying the ceramic green sheet by allowing the ceramic green sheet to pass through a plurality of drying zones, wherein positive internal differential pressure is applied to at least one of drying zones disposed at a front end thereof, the internal differential pressure being defined as a pressure value obtained by subtracting a discharging pressure (Pₒᵤₜ) of each drying zone from an introducing pressure (Pᵢₙ) thereof.

An air blacker, to which negative internal differential pressure is applied, may be disposed at an inlet of a drying zone disposed at the front end of the plurality of drying zones.

The ceramic green sheet may have a thickness of 2 μm or less, preferably, of 1 μm or less.

0 or negative internal differential pressure may be applied to at least one of drying zones disposed at a rear end of the plurality of drying zones.

The plurality of drying zones may number five or more, and the number of the drying zones disposed at the front end, to which the positive internal differential pressure is applied, may be more than that of the drying zones disposed at the rear end, to which 0 or the negative internal differential pressure is applied.

Air flow may be applied to at least one of an inlet of the drying zones disposed at the front end and an outlet of drying zones disposed at a rear end in order to prevent gas within each drying zone from being discharged to the outside.

According to another aspect of the present invention, there is provided a ceramic green sheet drying apparatus including: a support substrate allowing a ceramic green sheet formed of ceramic slurry to move thereon; and a plurality of drying zones arranged along a moving path of the support substrate, wherein positive internal differential pressure is applied to at least one of drying zones disposed at a front end thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a method of fabricating a ceramic green sheet applicable to an exemplary embodiment of the present invention;

FIG. 2 is a schematic view illustrating a ceramic green sheet drying apparatus according to an exemplary embodiment of the present invention;

FIGS. 3A and 3B are scanning electron microscope (SEM) images showing cross sections of ceramic green sheets obtained according to Inventive Example and Comparative Example; and

FIG. 4 is a graph showing the comparison of concentration of gas detected under pressure conditions of drying zones in Inventive Example and Comparative Example.

### DETAILED DESCRIPTION OF THE PREFERRED EMBODIMENT

Exemplary embodiments of the present invention will be described in detail with reference to the accompanying drawings.

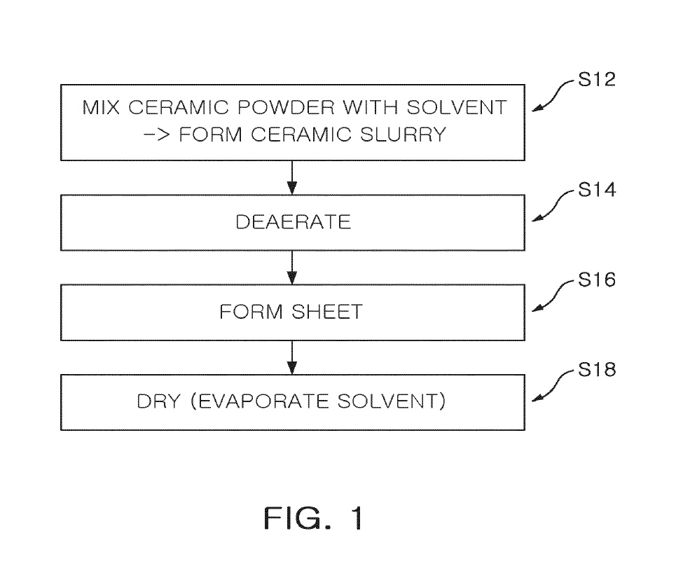

FIG. 1 is a flowchart illustrating a method of fabricating a ceramic green sheet applicable to an exemplary embodiment of the present invention.

Referring to FIG. 1, in a process for fabricating a ceramic green sheet, ceramic powders, a binder, and an organic solvent are mixed to prepare ceramic slurry (S12).

In the case of preparing the ceramic slurry for a multilayer ceramic capacitor, the ceramic powder may have a high dielectric constant. A material such as polyvinyl butyral (PVB) may be used as the binder, and alcohol may be used as the organic solvent.

Then, a deaeration operation for removing air bubbles from the ceramic slurry is performed (S14). The deaeration operation may be performed by placing the ceramic slurry under a vacuum. For example, the present operation may be performed by agitating the ceramic slurry in a vacuum or pseudo-vacuum state. In the present operation, the slurry may be maintained to have a desired viscosity range.

Next, the ceramic slurry is formed to have a sheet shape (S16). This sheet forming operation may be performed by a known method such as a doctor blade method to allow the sheet to have a desired thickness on a support substrate.

Thereafter, the formed ceramic green sheet is dried (S18). The solvent is evaporated from the ceramic green sheet through the drying operation, and thus a ceramic green sheet capable of being used to fabricate a ceramic electronic component is provided.

In order to form the ceramic green sheet as a thick-film (for example, a sheet exceeding 2 μm in thickness), the amount of slurry applied in the sheet forming operation will be increased. That is, in the case of the same solid slurry, even after being dried, a large amount of slurry will be applied in order to form a thick ceramic green sheet.

When a large amount of slurry is applied in order to form the sheet as described above, the amount of the solvent included in the slurry is increased correspondingly. It means that the amount of the solvent to be removed in the drying operation is increased.

In the case of the thick film, it may be advantageous in sufficiently drying the ceramic green sheet that each drying zone of a drying apparatus is maintained to discharge a greater amount of air than that introduced from the outside. That is, when a pressure value generated by subtracting a discharging pressure (Pₒᵤₜ) of each drying zone from an introducing pressure (Pᵢₙ) thereof is defined as internal differential pressure in the drying zone, it may be appropriate to maintain the differential pressure within the drying zone to be a negative pressure (−P) or a pressure (+/−P) close to 0 in a thick-film process.

On the other hand, in order to form the ceramic green sheet as a thin-film (for example, a sheet of 2 μm or less in thickness), the amount of the slurry applied in the sheet forming operation will be reduced. Therefore, the amount of the solvent included in the slurry may be significantly less than the case in which the ceramic green sheet is formed as the thick film. Accordingly, when the amount of the solvent included in the slurry is less than a threshold amount, the drying may be finished without rearranging ceramic particles and organic material such as a binder included in the slurry.

Meanwhile, in this case, since the concentration of gas within the drying zone is low, drying speed may be rapidly increased. As a result, a serious defect may occur during the drying of the ceramic green sheet. When the defective ceramic green sheet is used in a ceramic electronic component, the deterioration of electrical reliability such as short circuits may occur.

In consideration of this problem, in a method of fabricating a ceramic green sheet according to an exemplary embodiment of the present invention, a scheme for drying the ceramic green sheet in conditions in which the concentration of gas detected within the drying zone may be maintained at an appropriate level, simultaneously with slowing down the evaporation speed of the solvent, is proposed as being very advantageous for a process for fabricating a ceramic green sheet including a relatively small amount of solvent, typically, a ultrathin-film ceramic green sheet.

To this end, positive internal pressure is applied as the differential pressure within at least some drying zones disposed in a front end of a plurality of drying zones, unlike generally applying the negative internal pressure (−P) or the internal pressure (+/−P) close to 0 as the differential pressure (introducing pressure (Pᵢₙ)−discharging pressure (Pₒᵤₜ)) within all of the plurality of drying zones in order to effectively dry the ceramic green sheet.

Therefore, the evaporation speed of a small amount of solvent is appropriately controlled and the sufficient rearrangement time of the ceramic particles is secured, whereby a ceramic green sheet having very small defects may be fabricated.

In addition, since the drying zone is under the condition of the positive internal differential pressure, that is, the condition in which the introducing pressure (Pᵢₙ) is larger than the discharging pressure (Pₒᵤₜ), the introduction of foreign objects from the outside into the internal area of the drying zone is effectively suppressed, thereby maintaining the inside of the drying zone in a very clean state.

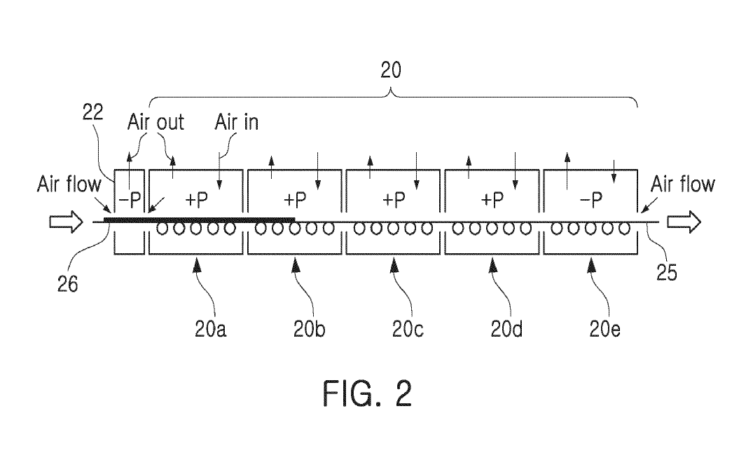

An example of a ceramic green sheet drying apparatus according to an exemplary embodiment of the present invention, to which the above-mentioned scheme is applied, is shown in FIG. 2. Referring to FIG. 2, a ceramic green sheet drying apparatus according to the present embodiment and a method of fabricating a ceramic green sheet using the same will be described.

The ceramic green sheet drying apparatus shown in FIG. 2 includes a support substrate 25 allowing a ceramic green sheet 26 to move thereon, and a plurality of drying zones arranged along a moving path of the support substrate 25. The present embodiment describes a case in which the number of drying zones 20 is five (20a to 20e); however, the present invention is not limited thereto.

As shown in FIG. 2, an air blocker 22 may be mounted at a front end of the plurality of drying zones 20a to 20e. The air blocker 22 may maintain strong negative pressure (−P), thereby preventing harmful organic solvent evaporated from slurry from being leaked to the outside and simultaneously preventing outside air from being introduced into the inside of the drying zones 20.

Relatively strong positive internal differential pressure is maintained in the drying zones 20a to 20c disposed at the front end of the plurality of drying zones 20 and having the ceramic green sheet 26 introduced thereinto.

In the present embodiment, 0 or negative internal differential pressure is applied to the drying zones 20d and 20e disposed at a rear end of the drying zones 20 as needed, such that remaining solvent after sufficient rearrangement of the ceramic particles may be evaporated. In addition, in order to ensure the sufficient rearrangement of the ceramic particles before the evaporation of the remaining solvent, the ceramic green sheet drying apparatus maybe designed to have the number of the drying zones 20d and 20e at the rear end thereof, to which 0 or the negative internal differential pressure is applied, at a level greater than that of the drying zones 20a to 20c at the front end, to which the positive internal differential pressure is applied.

More specifically, the strong positive internal differential pressure maybe maintained in a first drying zone 20a, a second drying zone 20b, and a third drying zone 20c according to order in a sheet movement direction. The internal differential pressure of the first to third drying zones may be maintained at 5 Pa or more. By slowing down the drying speed of a ceramic green sheet formed as an ultrathin film of 2 μm or less, particularly, of 1 μm or less, sufficient time to rearrange the ceramic particles and the organic binder may be secured.

The drying zones disposed at the rear end may not be employed or the number thereof may be changed according to a slurry condition or other drying conditions. In the present embodiment, however, the fourth and fifth drying zones disposed at the rear end are maintained to have the strong negative internal differential pressure (for example, strong internal differential pressure of −5 Pa or less), thereby securely evaporating the remaining solvent after rearrangement. In addition, the introduction of the outside air into the drying zones (particularly, positive internal differential pressure areas), in which the ceramic green sheet is dried, may be prevented.

As such, the drying zones according to the present embodiment have the negative internal differential pressure at the rear end thereof together with the air blocker against air introduction, while being maintained to have the positive internal differential pressure in most areas thereof, whereby the inside of the entire drying zones may be maintained in a very clean state. In addition, defects in the ceramic green sheet, generated due to the rapid evaporation of the solvent when the thin film is dried, may be prevented and the last remaining solvent maybe securely removed, so that the quality of the ceramic green sheet may be improved.

In the present embodiment, in order to prevent the harmful organic solvent from being leaked to the outside and to effectively block the introduction of outside air into the drying zone, air flow may be applied to at least one of an inlet and an outlet through which the ceramic green sheet passes.

Hereinafter, an effect of the present invention will be described in detail with reference to Inventive Example.

### INVENTIVE EXAMPLE

Ceramic powder was mixed with a binder and an organic solvent to prepare ceramic slurry, and then an ultrathin-film ceramic green sheet of 0.4 μm was formed.

The formed ultrathin-film ceramic green sheet was dried using a drying apparatus having five drying zones similar to the apparatus shown in FIG. 2. Herein, positive internal differential pressure was applied to first to third drying zones and negative internal differential pressure was applied to fourth and fifth drying zones, under conditions of internal differential pressure in each drying zone shown in Table 1 below.

### COMPARATIVE EXAMPLE

Under the same condition as that of the Inventive Example, ceramic powder was mixed with a binder and an organic solvent to prepare ceramic slurry, and then an ultrathin-film ceramic green sheet of 0.4 μm was formed.

The formed ultrathin-film ceramic green sheet was dried using a drying apparatus used in the Inventive Example; however, negative internal differential pressure was applied to all of the first to fifth drying zones under drying conditions shown in Table 1 below.

TABLE 1

| | First | Second | Third | Fourth | Fifth |
|---|---|---|---|---|---|
| | Drying | Drying | Drying | Drying | Drying |
| Classification | Zone | Zone | Zone | Zone | Zone |
| Inventive | +5 Pa | +5 Pa | +5 Pa | −5 Pa | −5 Pa |
| Example | or more | or more | or more | or less | or less |
| Comparative | −5 Pa | −5 Pa | −5 Pa | −5 Pa | −5 Pa |
| Example | or less | or less | or less | or less | or less |

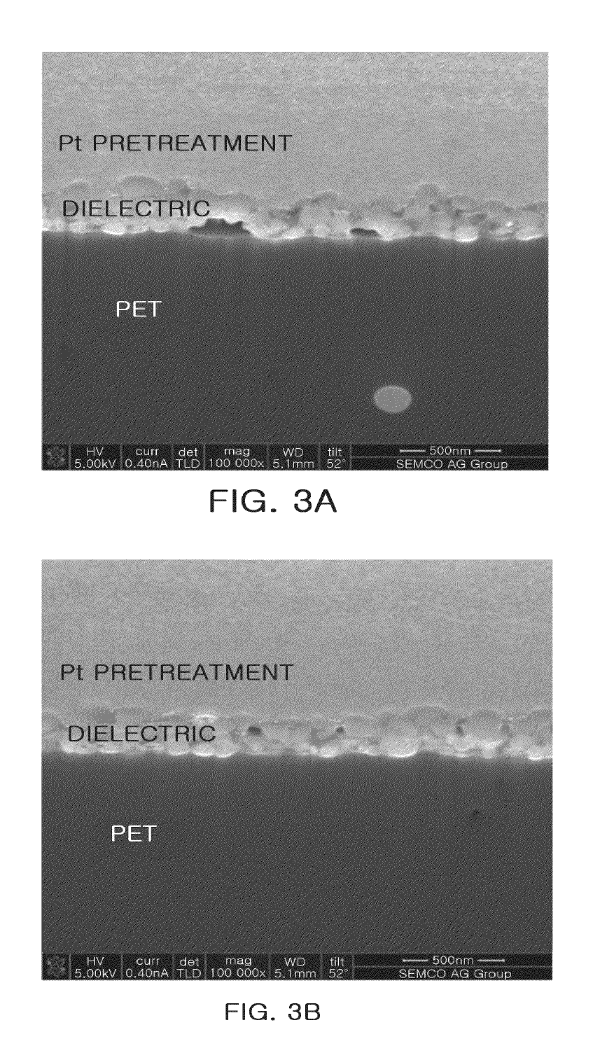

In order to confirm the degree of defect occurrence, each of the sections of the ceramic green sheets fabricated according to the Inventive and Comparative Examples were photographed with a scanning electron microscope (SEM). The images thereof are shown in FIGS. 3A and 3B.

It could be confirmed in FIG. 3A that many defects (shown as black) occurred in a dielectric area of the ceramic green sheet obtained according to the Comparative Example. On the other hand, it could be confirmed in FIG. 3B that in the ceramic green sheet obtained according to the Inventive Example, the number and size of defects were very small and the thickness of the high-density ultrathin film ceramic green sheetwas also uniformly maintained.

As described above, in the Comparative Example, the strong negative internal differential pressure was applied to the drying zones to form very low internal steam pressure, such that the drying speed of the slurry was very rapid. Accordingly, sufficient time to rearrange the ceramic particles was not secured, such that a ceramic green sheet having many defects and low density was fabricated. On the other hand, under the conditions of the Inventive Example, the strong positive internal differential pressure was applied to the drying zones to form very high internal steam pressure, such that the drying speed of the slurry was very slow. Accordingly, sufficient time to rearrange the ceramic particles was secured, such that a ceramic green sheet having no defects and high density was fabricated.

In addition, after drying the ceramic green sheet under the conditions according to each of the Inventive and Comparative Examples, the number of foreign objects within each drying zone was detected to measure the degree of cleanliness within each drying zone. The results thereof were shown in Table 2.

TABLE 2

| | Number of Foreign Objects | | Number of Foreign Objects | |
|---|---|---|---|---|
| | of 0.3 μm or more | | of 0.5 μm or more | |
| | Inventive | Comparative | Inventive | Comparative |
| Classification | Example | Example | Example | Example |
| First Drying | 13 | 99 | 1 | 35 |
| Zone | | | | |
| Second Drying | 3 | 95 | 2 | 24 |
| Zone | | | | |
| Third Drying | 32 | 121 | 5 | 31 |
| Zone | | | | |
| Fourth Drying | 25 | 85 | 3 | 10 |
| Zone | | | | |
| Fifth Drying | 42 | 82 | 8 | 11 |
| Zone | | | | |

Table 2 shows the number of the foreign objects within the drying zones according to the internal differential pressure of the drying zones. It could be confirmed that the number of the foreign objects within the drying zones according to the Inventive Example was significantly less than that within the drying zones according to the Comparative Example. That is, the Inventive Example could secure the higher degree of cleanliness than the Comparative Example in order to form the ceramic green sheet.

It could be confirmed that the pressure within the drying zones were mainly maintained to have the positive internal differential pressure, such that the foreign objects within the drying zones were discharged to the outside of the drying zones while being prevented from being introduced into the drying zones, whereby a high level of cleanliness was achieved.

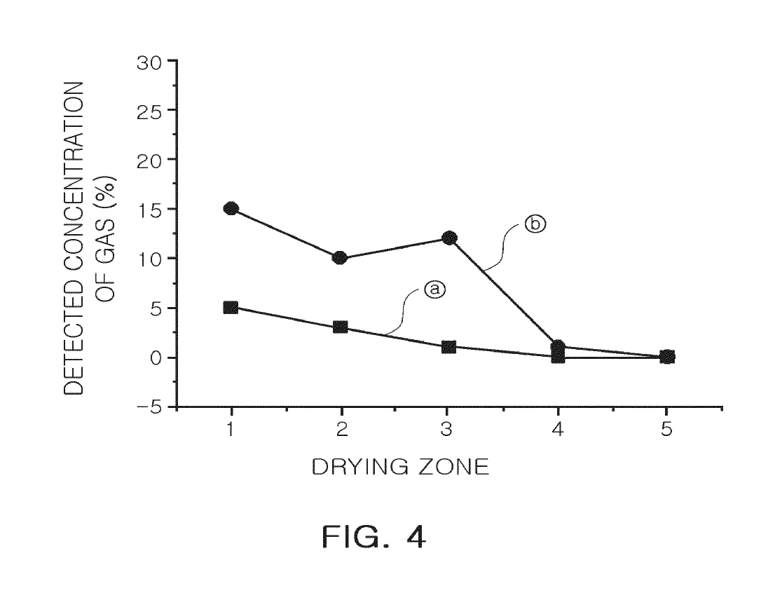

Meanwhile, after the drying is finished, the concentration of gas detected within each drying zone of the drying apparatus according to the Inventive and Comparative Examples were measured. The concentration of detected gas is an important factor in the management of the operations of the ceramic green sheet drying apparatus. When the lowest limit value of a gas explosion, which is a dangerous level, is set at 100%, the results of the concentration of detected gas within each drying zone are shown in FIG. 4.

It could be confirmed in FIG. 4 that while the Comparative Example had a high concentration of gas at a front end of the drying zones, the Inventive Example maintained a low concentration of gas in the fourth and fifth drying zones to which the negative differential pressure was applied in order to evaporate the remaining solvent, as well as at the front end. It may be understood from the results that the ceramic green sheet drying apparatus according to the Inventive Example is advantageous in terms of the management of the degree of danger related to gas.

As set forth above, the concentration of gas within drying zones maybe increased by changing internal differential pressure within the drying zones from 0 or a negative value to a positive value. When the concentration of gas within the drying zones is increased, the drying speed on a surface of the ceramic green sheet becomes slow, whereby a defect-free high-density ceramic green sheet can be fabricated.

The drying speed of a solvent evaporated from a surface of slurry is controlled to be slow, such that a high-density ultrathin-film ceramic green sheet may be fabricated. Particularly, the concentration of gas within the drying zones is adjusted to be a positive value by using the evaporated solvent, such that the cleanliness of the inside of the drying zones may be maintained to be high.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of fabricating a ceramic green sheet, the method comprising:
forming a ceramic green sheet by applying ceramic slurry to a support substrate; and
drying the ceramic green sheet by allowing the ceramic green sheet to pass through a plurality of drying zones,
wherein positive internal differential pressure is applied to at least one of drying zones disposed at a front end thereof, the internal differential pressure being defined as a pressure value obtained by subtracting a discharging pressure (Pₒᵤₜ) of each drying zone from an introducing pressure (Pᵢₙ) thereof.

2. The method of claim 1, wherein an air blacker, to which negative internal differential pressure is applied, is disposed at an inlet of a drying zone disposed at the front end of the plurality of drying zones.

3. The method of claim 1, wherein the ceramic green sheet has a thickness of 2 μm or less.

4. The method of claim 1, wherein 0 or negative internal differential pressure is applied to at least one of drying zones disposed at a rear end of the plurality of drying zones.

5. The method of claim 4, wherein the plurality of drying zones number five or more, and
the number of the drying zones disposed at the front end, to which the positive internal differential pressure is applied, is more than that of the drying zones disposed at the rear end, to which 0 or the negative internal differential pressure is applied.

6. The method of claim 1, wherein air flow is applied to at least one of an inlet of the drying zones disposed at the front end and an outlet of drying zones disposed at a rear end in order to prevent gas within each drying zone from being discharged to the outside.

7. A ceramic green sheet drying apparatus comprising:
a support substrate allowing a ceramic green sheet formed of ceramic slurry to move thereon; and
a plurality of drying zones arranged along a moving path of the support substrate,
wherein positive internal differential pressure is applied to at least one of drying zones disposed at a front end thereof, the internal differential pressure being defined as a pressure value obtained by subtracting a discharging pressure (Pₒᵤₜ) of each drying zone from an introducing pressure (Pᵢₙ) thereof.

8. The ceramic green sheet drying apparatus of claim 7, further comprising an air blocker disposed at an inlet of a drying zone disposed at the front end of the plurality of drying zones and having negative internal differential pressure applied thereto.

9. The ceramic green sheet drying apparatus of claim 7, wherein the ceramic green sheet has a thickness of 2 μm or less.

10. The ceramic green sheet drying apparatus of claim 7, wherein 0 or negative internal differential pressure is applied to at least one of drying zones disposed at a rear end of the plurality of drying zones.

11. The ceramic green sheet drying apparatus of claim 10, wherein the plurality of drying zones number five or more, and
the number of the drying zones disposed at the front end, to which the positive internal differential pressure is applied, is more than that of the drying zones disposed at the rear end, to which 0 or the negative internal differential pressure is applied.

12. The ceramic green sheet drying apparatus of claim 7, wherein air flow is applied to at least one of an inlet of the drying zones disposed at the front end and an outlet of drying zones disposed at a rear end in order to prevent gas within each drying zone from being discharged to the outside.
